(19) United States
(12) Patent Application Publication
(10) Pub. No.: US 2026/0204012 A1
(43) Pub. Date: Jul. 16, 2026

(54) DATA PROTECTION METHOD, WEARABLE DEVICE AND NON-TRANSITORY COMPUTER READABLE STORAGE MEDIUM

(71) Applicant: HTC Corporation, Taoyuan City (TW)

(72) Inventors: Cheng-Han HSIEH, Taoyuan City (TW); Hung-Lung HUANG, Taoyuan City (TW); Meng-Chi TSAI, Taoyuan City (TW)

(21) Appl. No.: 19/026,119

(22) Filed: Jan. 16, 2025

(51) Int. Cl. G06T 17/00; G06T 7/73; G06V 10/44

(52) U.S. Cl. CPC G06T 17/00; G06T 7/73; G06V 10/44

(57) ABSTRACT

The present disclosure provides a data protection method and a wearable device. The data protection method is applicable to the wearable device including a processor and a display panel, and includes: by the processor, locking a data object in an immersive environment provided by the display panel; by the processor, obtaining a first feature data of a candidate object; and in response to the first feature data satisfying a predetermined standard, by the processor, generating an anchor information according to the first feature data of the candidate object, wherein the anchor information is configured to be used to unlocking the data object being locked.

### BACKGROUND

### Field Of Invention

This disclosure relates to a method and a device, and in particular to a data protection method and a wearable device.

### Description of Related Art

These days, many people use mobile devices (e.g., smartphone, tablet, laptop, etc.) daily for things such as communication, work, gaming, etc. It should be noted that the locking/unlocking function is usually inherent in each mobile device in order to protect privacy information stored in each mobile device. In comparison to those mobile devices, the existing virtual reality devices (e.g., a head mounted display (HMD)) do not provide the people with the convenient and efficient way to lock/unlock the privacy information, which raises concerns about information security.

### SUMMARY

An aspect of present disclosure relates to a data protection method. The data protection method is applicable to a wearable device including a processor and a display panel, and includes: by the processor, locking a data object in an immersive environment provided by the display panel; by the processor, obtaining a first feature data of a candidate object; and in response to the first feature data satisfying a predetermined standard, by the processor, generating an anchor information according to the first feature data of the candidate object, wherein the anchor information is configured to be used to unlocking the data object being locked.

Another aspect of present disclosure relates to a wearable device. The wearable device includes a display panel and a processor. The display panel is configured to provide an immersive environment including a data object. The processor is coupled to the display panel, and is configured to: lock the data object; obtain a first feature data of a candidate object; and in response to the first feature data satisfying a predetermined standard, generate an anchor information according to the first feature data of the candidate object, wherein the anchor information is configured to be used to unlocking the data object being locked.

Another aspect of present disclosure relates to a non-transitory computer readable storage medium with a computer program to execute a data protection method, wherein the data protection method is applicable to a wearable device including a processor and a display panel, and includes: by the processor, locking a data object in an immersive environment provided by the display panel; by the processor, obtaining a first feature data of a candidate object; and in response to the first feature data satisfying a predetermined standard, by the processor, generating an anchor information according to the first feature data of the candidate object, wherein the anchor information is configured to be used to unlocking the data object being locked.

It is to be understood that both the foregoing general description and the following detailed description are by examples, and are intended to provide further explanation of the invention as claimed.

### BRIEF DESCRIPTION OF THE DRAWINGS

The present disclosure can be more fully understood by reading the following detailed description of the embodiment, with reference made to the accompanying drawings as follows:

FIG. 1 is a schematic diagram of a wearable device operable by a user in accordance with some embodiments of the present disclosure;

FIG. 2 is a flow diagram of a data protection method in accordance with some embodiments of the present disclosure;

FIG. 3 is a schematic diagram of the wearable device generating an anchor information in accordance with some embodiments of the present disclosure;

FIG. 4 is a schematic diagram of a spatial location of a data object relative to a candidate object in accordance with some embodiments of the present disclosure;

FIG. 5 is a flow diagram of the data protection method in accordance with some embodiments of the present disclosure;

FIG. 6 is a schematic diagram of the wearable device obtaining an access information in accordance with some embodiments of the present disclosure; and

FIG. 7 is a schematic diagram of a virtual reality object being a candidate object in accordance with some embodiments of the present disclosure.

### DETAILED DESCRIPTION

The embodiments are described in detail below with reference to the appended drawings to better understand the aspects of the present application. However, the provided embodiments are not intended to limit the scope of the disclosure, and the description of the structural operation is not intended to limit the order in which they are performed. Any device that has been recombined by components and produces an equivalent function is within the scope covered by the disclosure.

As used herein, “coupled” and “connected” may be used to indicate that two or more elements physical or electrical contact with each other directly or indirectly, and may also be used to indicate that two or more elements cooperate or interact with each other.

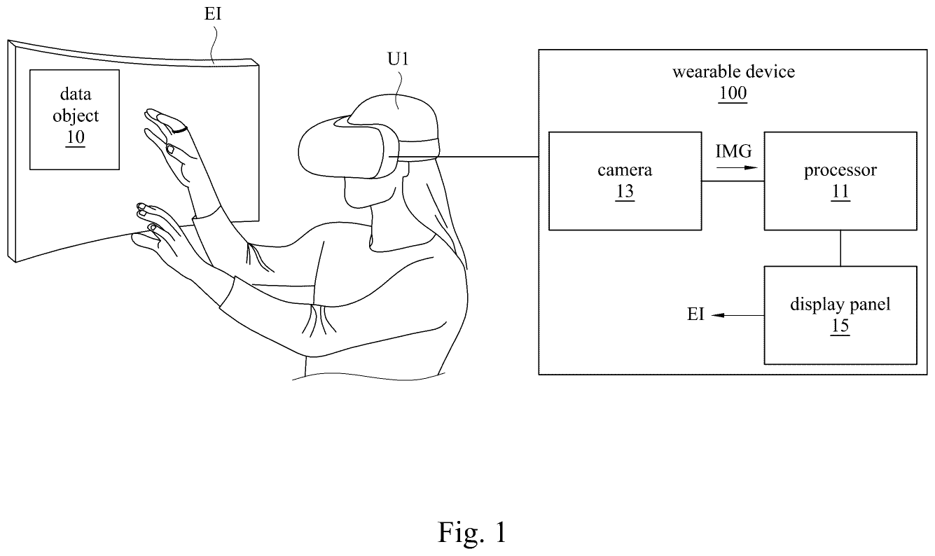

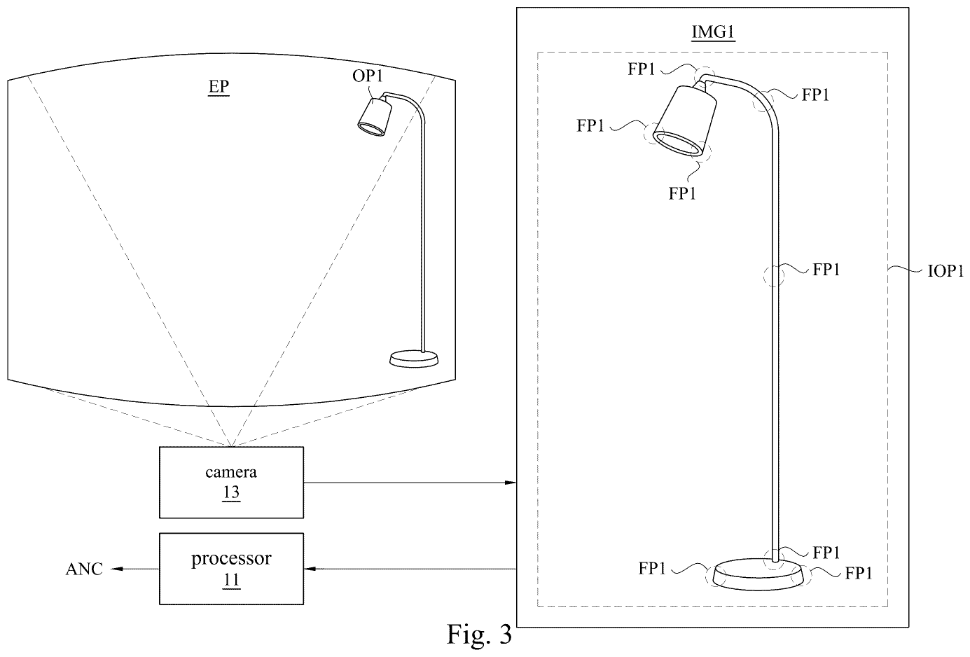

Referring to FIG. 1, FIG. 1 is a schematic diagram of a wearable device 100 in accordance with some embodiments of the present disclosure. In some embodiments, the wearable device 100 can be implemented by a head mounted display (HMD), and can be worn on the head of a user U1, so as to provide an immersive environment EI for the user U1. Furthermore, the wearable device 100 can be operated by the user U1 in a physical environment EP (shown in FIG. 3), such as a gaming place, a workplace, a house, etc.

In the embodiments of FIG. 1, the immersive environment EI includes a data object 10, and the data object 10, such as a photo, a video, a text file, a folder for organizing computer files, an application, etc., may have privacy information of the user U1. Notably, by the wearable device 100 obtaining information from the physical environment EP and/or the immersive environment EI, the user U1 can protect the data object 10 in the immersive environment EI from unauthorized access.

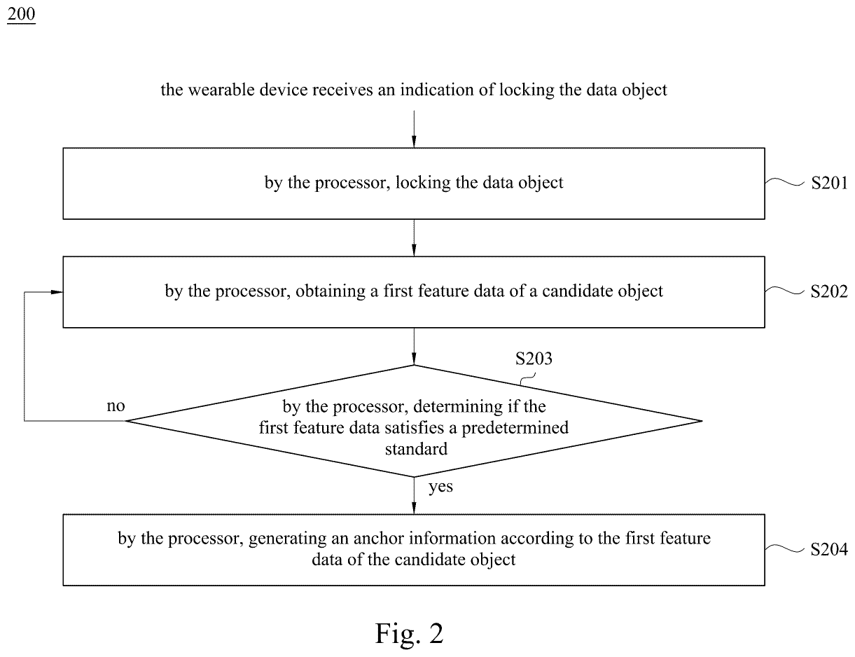

Accordingly, in some embodiments, as shown in FIG. 1, the wearable device 100 includes a processor 11, a camera 13 and a display panel 15. In particular, the processor 11 is electrically and/or communicatively coupled to the camera 13 and the display panel 15. The camera 13 can consist of one or more units and be positioned at different angular locations on the wearable device 100. The camera 13 is configured to capture multiple image frames IMG in the physical environment EP. It should be understood that these image frames IMG may include at least one of images of the whole or partial physical environment EP and images of the user U1's hand or controller for some interactions and operations. By applying some feature extraction based localization technologies (e.g., Simultaneous Localization and Mapping (SLAM)) to the image frames IMG captured by the camera 13, the processor 11 is configured to establish a map data of the physical environment EP, and is further configured to calculate the position and/or orientation of the wearable device 100 in the map data. Also, the processor 11 is configured to generate multiple visual contents according to the positions and/or orientation of the wearable device 100. The display panel 15 is configured to display the visual contents generated by the processor 11, so as to provide the immersive environment EI for the user U1. In addition, other operations of the processor 11, the camera 13 and the display panel 15 would be described later with reference to FIG. 2.

In some embodiments, the wearable device 100 may occlude the direct visibility of the user U1 to the physical environment EP. In this case, the immersive environment EI can be a virtual reality (VR) environment, or a mixed reality (MR) environment. In particular, the VR environment may include at least one virtual object, which cannot be directly seen in the physical environment EP by the user U1. The MR environment simulates the physical environment EP and enables an interaction of the at least one virtual object with a simulated physical environment. However, the present disclosure is not limited herein. For example, the immersive environment EI can be the simulated physical environment without any virtual object, which is known as a pass-through view.

In some embodiments, the wearable device 100 does not occlude the direct visibility of the user U1 to the physical environment EP. In this case, the immersive environment EI can be an augmented reality (AR) environment. In particular, the AR environment augments the physical environment EP directly seen by the user U1 with the at least one virtual object.

Moreover, in accordance with the above embodiments that the immersive environment EI is the VR, MR or AR environment, the user U1 can control the at least one virtual object in the immersive environment EI by operating at least one controller communicatively coupled to the wearable device 100 or by the hand movements of the user U1.

As should be understood, in some embodiments, the wearable device 100 can further include a motion sensor (e.g., an inertial measurement unit (IMU) including an accelerometer, a gyroscope and a magnetometer), a storage (e.g., a volatile memory, a non-volatile memory, etc.) and/or a communicator (e.g., a Wi-Fi module, a Bluetooth Low Energy (BLE) module, a Bluetooth module, etc.). The motion sensor can be used to sense the movement of the wearable device 100 to generate motion data correspondingly. The storage can be used to store signals, data and/or information, such as the motion data, the image frames IMG, the map data, the position and/or orientation of the wearable device 100, etc. The wearable device 100 can use communicator to communicate with other devices (e.g., transferring signals, data and/or information).

FIG. 2 is a flow diagram of a data protection method 200 applicable to the wearable device 100 in accordance with some embodiments of the present disclosure. In some embodiments, the wearable device 100 executing the data protection method 200 can achieve the protection for the data object 10 from unauthorized access. As shown in FIG. 2, the data protection method 200 includes operations S201-S204. However, the present disclosure should not be limited thereto.

In some embodiments, the user U1 intends to lock the data object 10, and operates the wearable device 100 correspondingly. For example, the user U1 performs a preset movement, such as a double click on the data object 10 with any finger, pressing a preset button on the controller while pointing the data object 10 with the controller, etc., in the immersive environment EI. After the user U1 performs the preset movement, the wearable device 100 receives an indication of locking the data object 10 through the processor 11. It should be understood that the indication of locking the data object 10 can be transmitted in the form of signal, data or information. In response to the indication of locking the data object 10, operation S201 is executed.

In operation S201, the processor 11 locks the data object 10. In some embodiments, the data object 10 is image data or text data, and the processor 11 locks the data object 10 by applying a blurred effect to the image data or the text data. In some embodiments, the data object 10 is a computer folder or an application, and the processor 11 locks the data object 10 by restricting the access to the computer folder or the application.

In some embodiments, while or after receiving the indication of locking the data object 10, the wearable device 100 audibly and/or visibly notifies the user U1 of making a start on an individual setting for unlocking the data object 10 thereafter. Accordingly, operations S202-S204 may be executed in sequence, which would be described in detail with reference to FIG. 3. FIG. 3 is a schematic diagram of the operation of the wearable device 100 during the above-described individual setting in accordance with some embodiments of the present disclosure. It should be understood that operations S202-S204 can be executed while, before or after operation S201 is executed.

In operation S202, the processor 11 obtains a first feature data of a candidate object. In some embodiments, the user U1 selects a physical object OP1 in the physical environment EP as the candidate object by pointing the physical object OP1 through the controller or the hand, to meet the requirements of the above-described individual setting. While the user U1 points the physical object OP1, the camera 13 captures at least one image frame IMG1. As shown in FIG. 3, the image frame IMG1 includes an image IOP1 of the physical object OP1. The processor 11 receives the image frame IMG1 from the camera 13, and extracts multiple feature points FP1 from the image IOP1 of the physical object OP1 by the feature extraction based localization technologies. Furthermore, in some embodiments, the processor 11 calculates an amount of the feature points FP1, to obtain the first feature data of the candidate object.

In operation S203, the processor 11 determines if the first feature data of the candidate object satisfies a predetermined standard. In some embodiments of operation S203, the first feature data of the candidate object indicates the amount of the feature points FP1 extracted from the image IOP1 of the physical object OP1, and the processor 11 determines if the amount of the feature points FP1 is greater than an amount threshold accordingly. In particular, when the amount of the feature points FP1 is greater than the amount threshold, the processor 11 determines that the first feature data of the candidate object satisfies the predetermined standard, so that operation S204 is executed. When the amount of the feature points FP1 is not greater than the amount threshold, the processor 11 determines that the first feature data of the candidate object does not satisfy the predetermined standard, so that operation S202 is executed again. From the descriptions of operation S203, it can be seen that the predetermined standard includes the amount of the feature points FP1 corresponding to the candidate object being greater than the amount threshold in some embodiments, but the present disclosure is not limited herein.

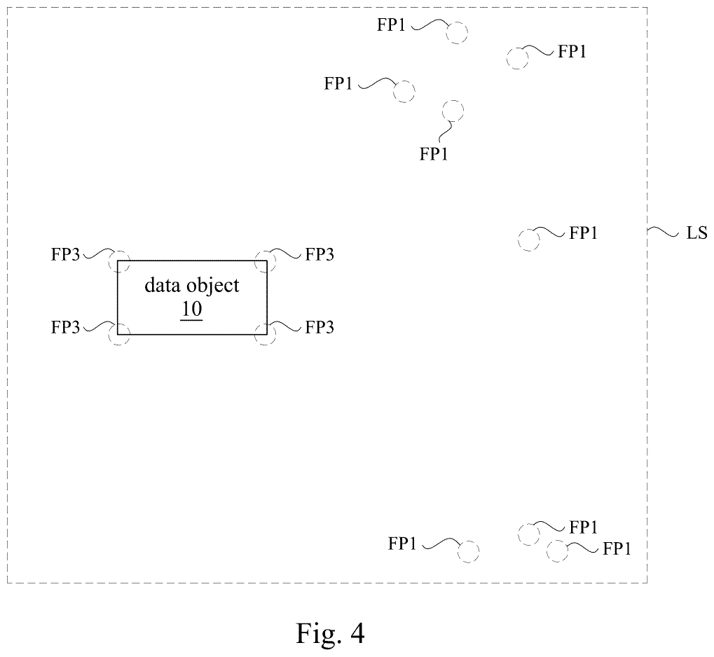

In operation S204, the processor 11 generates an anchor information ANC according to the first feature data of the candidate object. In some embodiments, by the feature extraction based localization technologies, the processor 11 can further match the feature points FP1 extracted from the image IOP1 of the physical object OP1 to multiple map points (not shown) in the map data, to obtain a spatial distribution of the feature points FP1 in the map data. It should be understood that the spatial distribution of the feature points FP1 can also be regarded as the first feature data of the candidate object. That is to say, the first feature data of the candidate object can include at least one of the amount of the feature points FP1 and the spatial distribution of the feature points FP1. In some embodiments of operation S204, the processor 11 links the first feature data of the candidate object with an identification name, to generate the anchor information ANC. For example, the processor 11 uses the storage of the wearable device 100 to store the first feature data of the candidate object in the form of computer file, and names the computer file as the identification name. The present disclosure does not limit the anchor information ANC to being generated according to the first feature data of the candidate object (i.e., at least one of the amount of the feature points FP1 and the spatial distribution of the feature points FP1), which would be described below with reference to FIG. 4.

FIG. 4 is a schematic diagram of a spatial location LS of the data object 10 relative to the candidate object in accordance with some embodiments of the present disclosure. In some embodiments, the processor 11 obtains multiple feature points FP3 of the data object 10, which are stored in a virtual object database (not shown). Each feature point FP3 can include a descriptor capable of indicating a spatial coordinate in the map data and features of the data object 10 (e.g., color, shape, texture, etc.). The processor 11 uses the feature points FP1 extracted from the image IOP1 of the physical object OP1 and the feature points FP3 of the data object 10 to obtain the spatial location LS of the data object 10 relative to the candidate object. In particular, the spatial location LS of the data object 10 relative to the candidate object can represent a spatial distribution of the feature points FP1 and the feature points FP3. It should be noted that the user U1 can be instructed by the wearable device 100 to move the data object 10 and/or the physical object OP1 (i.e., the candidate object) to set the spatial location LS of the data object 10 relative to the candidate object. In some embodiments of operation S204, the processor 11 links the spatial location LS of the data object 10 relative to the candidate object with the identification name. From the descriptions of FIGS. 3 and 4, it can be seen that the processor 11 can link at least one of the first feature data of the candidate object and the spatial location LS of the data object 10 relative to the candidate object with the identification name, to generate the anchor information ANC.

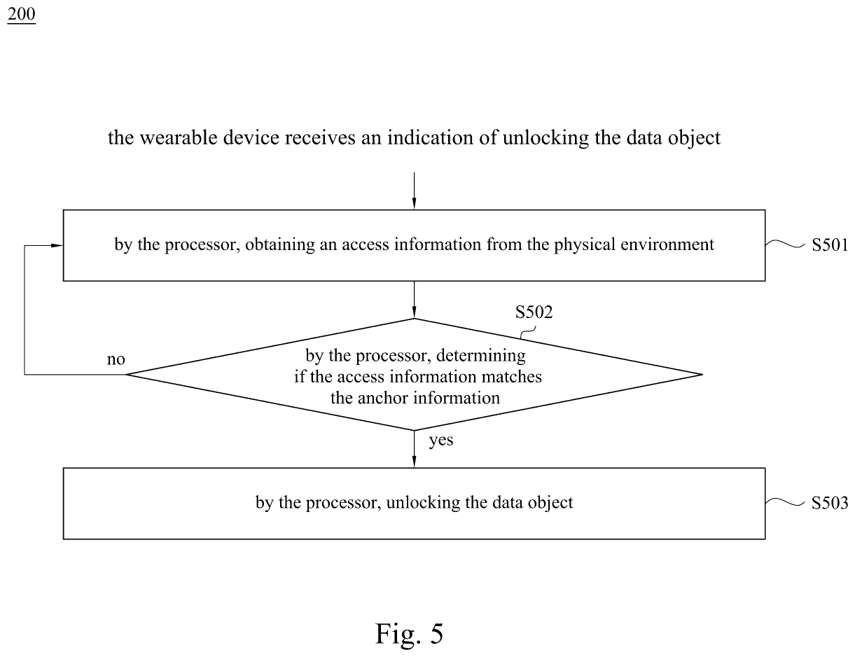

In the above embodiments, the anchor information ANC is configured to be used to unlocking the data object 10 being locked, which would be described with reference to FIG. 5. FIG. 5 is a flow diagram of the data protection method 200 in accordance with some embodiments of the present disclosure. In some embodiments, the data protection method 200 further includes operations S501-S503.

In some embodiments, the user U1 intends to unlock the data object 10 being locked, and operates the wearable device 100 correspondingly. For example, the user U1 performs another preset movement, such as a click on the data object 10 with any finger, pointing the data object 10 with the controller, etc., in the immersive environment EI. After the user U1 performs said another preset movement, the wearable device 100 receives an indication of unlocking the data object 10 through the processor 11. It should be understood that the indication of unlocking the data object 10 can be transmitted in the form of signal, data or information. In the embodiments of FIG. 5, after the wearable device 100 receives the indication of locking the data object 10, operation S501 is executed. However, the indication of unlocking the data object 10 should not be limited to being generated in response to the user U1 performing said another preset movement. For example, in some embodiments, the wearable device 100 can detect if the user U1 turns towards or approaches the data object 10 by its sensor. If the user U1 turns towards or approaches the data object 10, the sensor can generate the indication of unlocking the data object 10 to the processor 11, so that operation S501 is executed.

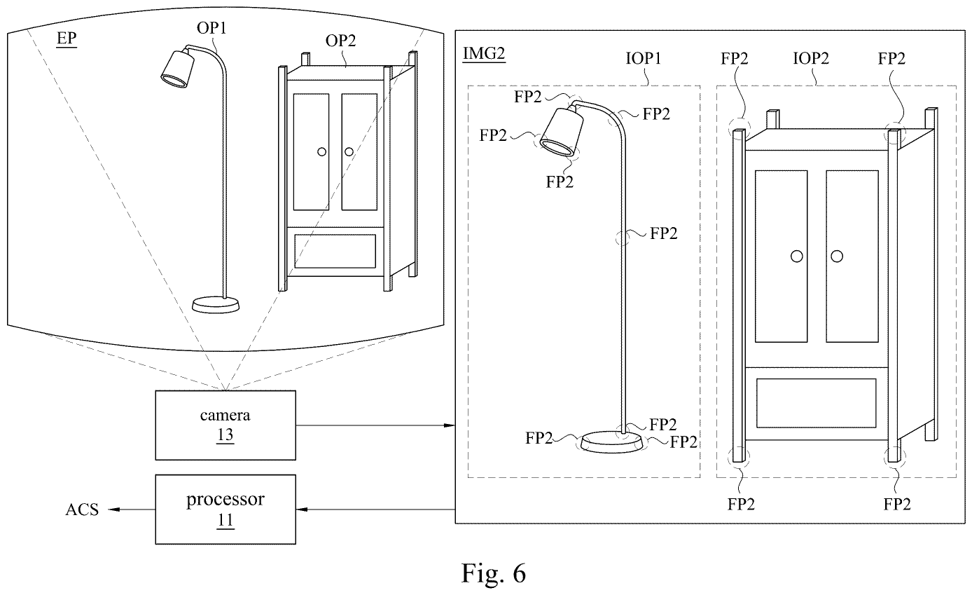

In operation S501, the processor 11 obtains an access information ACS from the physical environment EP, which would be described in detail with reference to FIG. 6. FIG. 6 is a schematic diagram of the wearable device 100 obtaining the access information ACS in accordance with some embodiments of the present disclosure. In some embodiments, the camera 13 captures at least one image frame IMG2 of the physical environment EP. As shown in FIG. 6, the image frame IMG2 includes the image IOP1 of the physical object OP1 and an image IOP2 of another physical object OP2. The processor 11 receives the image frame IMG2 from the camera 13, and extracts multiple feature points FP2 from the image frame IMG2 by the feature extraction based localization technologies. In particular, some feature points FP2 are extracted from the image IOP1 of the physical object OP1, and the other feature points FP2 are extracted from the image IOP2 of the physical object OP2. These feature points FP2 can be used as the access information ACS, but the present disclosure is not limited herein.

In operation S502, the processor 11 determines if the access information ACS matches the anchor information ANC. In some embodiments, the anchor information ANC includes the first feature data of the candidate object (i.e., at least one of the amount of the feature points FP1 and the spatial distribution of the feature points FP1). Accordingly, the processor 11 can compare the feature points FP1 of the anchor information ANC with the feature points FP2 of the access information ACS, to determine if the access information ACS matches the anchor information ANC.

In accordance with the above descriptions, in the embodiments of FIG. 6, the processor 11 finds the feature points FP2 extracted from the image IOP1 in the image frame IMG2 (which are regarded as a matched feature portion hereafter), which match the feature points FP1 extracted from the image IOP1 in the image frame IMG1. That is to say, the matched feature portion indicates the same amount and/or spatial distribution of feature points as those of the anchor information ANC. Thus, the processor 11 determines that the access information ACS matches the anchor information ANC, so that operation S503 is executed. In some embodiments, the processor 11 may find none of the feature points FP2 matching the feature points FP1 of the anchor information ANC, and then determines that the access information ACS does not match the anchor information ANC, so that operation S501 is executed again. From the above descriptions, it can be seen that the processor 11 determines if the access information ACS matches the anchor information ANC through the comparison between the first feature data of the candidate object (i.e., the anchor information ANC) and a second feature data of the access information ACS (e.g., the feature points FP2).

In operation S503, the processor 11 unlocks the data object 10. In some embodiments, the processor 11 removes the blurred effect from the data object 10 (which is the image data or the text data) or cancels the restriction on the data object 10 (which is the computer folder or the application), to unlock the data object 10.

The present disclosure does not limit the access information ACS to the amount and/or spatial distribution of the feature points FP2 extracted from the image frame IMG2. For example, in some embodiments, the anchor information ANC includes the spatial location LS of the data object 10 relative to the candidate object (i.e., the spatial distribution of the feature points FP1 and the feature points FP3). Accordingly, in the embodiments of operation S501, the processor 11 further uses the matched feature portion in the feature points FP2 and current feature data of the data object 10 (which may be the feature points FP3 or other feature points updated from the feature points FP3) to obtain a current spatial location of the data object 10 relative to the physical object OP1. That is to say, the access information ACS can include at least one of the second feature data extracted from the image frame IMG2 and the current spatial location of the data object 10 relative to the physical object OP1. In the embodiments of operation S502, the processor 11 further compares the current spatial location of the data object 10 relative to the physical object OP1 with the spatial location LS of the anchor information ANC. When the current spatial location of the data object 10 relative to the physical object OP1 is substantially equal to the spatial location LS of the anchor information ANC, the processor 11 determines the access information ACS matches the anchor information ANC, so that operation S503 is executed.

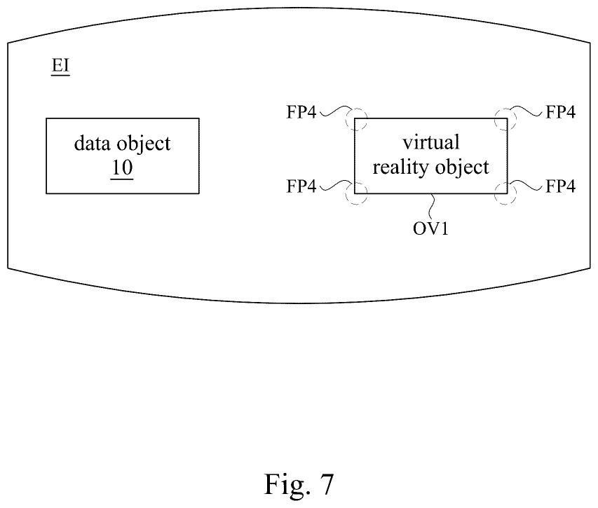

The present disclosure does not limit the candidate object to be the physical object OP1. Referring to FIG. 7, FIG. 7 is a schematic diagram of a virtual reality object OV1 being the candidate object in accordance with some embodiments of the present disclosure. In some embodiments, the user U1 selects the virtual reality object OV1 in the immersive environment EI as the candidate object by pointing the virtual reality object OV1 through the controller or the hand, to meet the requirements of the above-described individual setting. In some embodiments of operation S202, while the user U1 points the virtual reality object OV1, the processor 11 obtains multiple feature points FP4 of the virtual reality object OV1, which are stored in the virtual object database. Furthermore, the processor 11 calculates an amount of the feature points FP4, to obtain the first feature data of the candidate object. When the amount of the feature points FP4 is greater than the amount threshold, in some embodiments of operation S204, the processor 11 can use the amount of the feature points FP4, a spatial distribution of the feature points FP4 and/or a spatial location of the data object 10 relative to the virtual reality object OV1 being the candidate object as the anchor information ANC.

In accordance with the above descriptions, if the user U1 intends to unlock the data object 10, the user U1 is required to ensure the virtual reality object OV1 existing in the immersive environment EI. In some embodiments of operation S501, the processor 11 obtains the second feature data from the immersive environment EI. If the second feature data includes the feature points FP4 or other feature points updated from the feature points FP4 (that is, the virtual reality object OV1 exists in the immersive environment EI), in some embodiments of operation S502, the processor 11 may determine that the access information ACS matches the anchor information ANC because a portion of feature points in the second feature data (e.g., the feature points FP4 or other feature points updated from the feature points FP4) has the same amount and/or spatial distribution of feature points as those of the anchor information ANC.

When the anchor information ANC includes the spatial location of the data object 10 relative to the virtual reality object OV1 being the candidate object, in some embodiments of operation S501, the processor 11 further obtains a current spatial location of the data object 10 relative to the virtual reality object OV1 according to current feature data of the data object 10 (which may be the feature points FP3 or other feature points updated from the feature points FP3) and the above-described portion of feature points in the second feature data.

In some further embodiments of FIG. 2, operations S202-S204 can be executed multiple times to generate multiple anchor information ANC which are corresponding to different candidate objects. It should be understood that these different candidate objects can include, for example at least one of the physical object OP1 in the physical environment EP and the virtual reality object OV1 in the immersive environment EI. Accordingly, in some embodiments of operation S501, the processor 11 should obtain the access information ACS from at least one of the physical environment EP and the immersive environment EI. In addition, it should be understood that the physical environment EP and the immersive environment EI each can also be selected as the candidate object in some embodiments.

In the above embodiments, the processor 11 can be implemented by a central processing unit (CPU), an application-specific integrated circuit (ASIC), a microprocessor, a system on a Chip (SoC) or other suitable processing circuits. The display panel 15 can be implemented by an active matrix organic light emitting diode (AMOLED) display, organic light emitting diode (OLED) display, or other suitable displays.

As can be seen from the above embodiments of the present disclosure, the wearable device 100 can acquire feature data from the physical environment EP and/or the immersive environment EI to generate the anchor information ANC as a key for unlocking or decryption. When the feature data acquired from the physical environment EP and/or the immersive environment EI are private or not easy to obtain by someone other than the user U1, the wearable device 100 can effectively protect the data object 10 in the immersive environment EI from unauthorized access. That is to say, the wearable device 100 and the data protection method 200 of the present disclosure have advantages of increasing the confidentiality of the key for unlocking or decryption.

The disclosed methods, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the at least one processor to provide a unique apparatus that operates analogously to application specific logic circuits.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the invention. In view of the foregoing, it is intended that the present invention cover modifications and variations of this invention provided they fall within the scope of the following claims.

What is claimed is:

1. A data protection method, applicable to a wearable device comprising a processor and a display panel, and comprising:
by the processor, locking a data object in an immersive environment provided by the display panel;
by the processor, obtaining a first feature data of a candidate object; and
in response to the first feature data satisfying a predetermined standard, by the processor, generating an anchor information according to the first feature data of the candidate object, wherein the anchor information is configured to be used to unlocking the data object being locked.

2. The data protection method of claim 1, wherein the candidate object is a physical object in a physical environment where the wearable device is operated, the wearable device further comprises a camera, and obtaining the first feature data of the candidate object comprises:
by the camera, capturing at least one image of the physical object; and
by the processor, calculating an amount of feature points extracted from the at least one image of the physical object, to obtain the first feature data of the candidate object.

3. The data protection method of claim 1, wherein the candidate object is a virtual reality object in the immersive environment, and obtaining the first feature data of the candidate object comprises:
by the processor, calculating an amount of feature points of the virtual reality object, to obtain the first feature data of the candidate object.

4. The data protection method of claim 1, further comprising:
by the processor, determining if an amount of feature points indicated by the first feature data is greater than an amount threshold, wherein the first feature data satisfies the predetermined standard when the amount of feature points is greater than the amount threshold.

5. The data protection method of claim 1, wherein generating the anchor information according to the first feature data of the candidate object comprises:
by the processor, linking at least one of the first feature data of the candidate object and a spatial location of the data object relative to the candidate object with an identification name, to generate the anchor information, wherein the first feature data of the candidate object indicates an amount of feature points and a spatial distribution of feature points.

6. The data protection method of claim 1, further comprising:
in response to an indication of unlocking the data object, by the processor, obtaining an access information from at least one of a physical environment where the wearable device is operated and the immersive environment; and
in response to the access information matching the anchor information, unlocking the data object.

7. The data protection method of claim 6, wherein the candidate object is a physical object in the physical environment, the wearable device further comprises a camera, and obtaining the access information from at least one of the physical environment and the immersive environment comprises:
by the camera, capturing at least one image frame of the physical environment; and
by the processor, extracting a second feature data from the at least one image frame of the physical environment.

8. The data protection method of claim 7, further comprising:
by the processor, obtaining a spatial location of the data object relative to the physical object according to a third feature data of the data object and the second feature data.

9. The data protection method of claim 6, wherein the candidate object is a virtual reality object in the immersive environment, and obtaining the access information from at least one of the physical environment and the immersive environment comprises:
by the processor, obtaining a second feature data from the immersive environment.

10. The data protection method of claim 6, wherein the access information comprises a second feature data obtained from one of the physical environment and the immersive environment, and the data protection method further comprises:
by the processor, determining if the access information matches the anchor information through a comparison between the second feature data and the first feature data.

11. A wearable device, comprising:
a display panel, configured to provide an immersive environment comprising a data object; and
a processor, coupled to the display panel, and configured to:
lock the data object;
obtain a first feature data of a candidate object; and
in response to the first feature data satisfying a predetermined standard, generate an anchor information according to the first feature data of the candidate object, wherein the anchor information is configured to be used to unlocking the data object being locked.

12. The wearable device of claim 11, wherein the candidate object is a physical object in a physical environment where the wearable device is operated, the wearable device further comprises a camera, the camera is configured to capture at least one image of the physical object, and the processor is configured to calculate an amount of feature points extracted from the at least one image of the physical object, to obtain the first feature data of the candidate object.

13. The wearable device of claim 11, wherein the candidate object is a virtual reality object in the immersive environment, and the processor is configured to calculate an amount of feature points of the virtual reality object, to obtain the first feature data of the candidate object.

14. The wearable device of claim 11, wherein the processor is further configured to determine if an amount of feature points indicated by the first feature data is greater than an amount threshold, wherein the first feature data satisfies the predetermined standard when the amount of feature points is greater than the amount threshold.

15. The wearable device of claim 11, wherein the processor is configured to link at least one of the first feature data of the candidate object and a spatial location of the data object relative to the candidate object with an identification name, to generate the anchor information, wherein the first feature data of the candidate object indicates an amount of feature points and a spatial distribution of feature points.

16. The wearable device of claim 11, wherein the processor is further configured to:
in response to an indication of unlocking the data object, obtain an access information from at least one of a physical environment where the wearable device is operated and the immersive environment; and
in response to the access information matching the anchor information, unlock the data object.

17. The wearable device of claim 16, wherein the candidate object is a physical object in the physical environment, the wearable device further comprises a camera, the camera is configured to capture at least one image frame of the physical environment, and the processor is configured to extract a second feature data from the at least one image frame of the physical environment as the access information.

18. The wearable device of claim 16, wherein the candidate object is a virtual reality object in the immersive environment, and the processor is configured to obtain a second feature data from the immersive environment as the access information.

19. The wearable device of claim 16, wherein the access information comprises a second feature data obtained from one of the physical environment and the immersive environment, and the processor is further configured to determine if the access information matches the anchor information through a comparison between the second feature data and the first feature data.

20. A non-transitory computer readable storage medium with a computer program to execute a data protection method, wherein the data protection method is applicable to a wearable device comprising a processor and a display panel, and comprises:
by the processor, locking a data object in an immersive environment provided by the display panel;
by the processor, obtaining a first feature data of a candidate object; and
in response to the first feature data satisfying a predetermined standard, by the processor, generating an anchor information according to the first feature data of the candidate object, wherein the anchor information is configured to be used to unlocking the data object being locked.
